(19) United States
(12) Patent Application Publication
(10) Pub. No.: US 2018/0257978 A1
(43) Pub. Date: Sep. 13, 2018

(54) PLATE WITH PRINT LAYER, DISPLAY DEVICE USING SAME, AND GLASS WITH FUNCTIONAL LAYER FOR IN-VEHICLE DISPLAY DEVICES

(71) Applicant: ASAHI GLASS COMPANY, LIMITED, Chiyoda-ku (JP)

(72) Inventors: Jun MINAMIDATE, Tokyo (JP); Takeshi HIROSE, Tokyo (JP); Makoto FUJII, Tokyo (JP)

(73) Assignee: ASAHI GLASS COMPANY, LIMITED, Chiyoda-ku (JP)

(21) Appl. No.: 15/973,959

(22) Filed: May 8, 2018

Related U.S. Application Data
(63) Continuation of application No. PCT/JP2016/082946, filed on Nov. 7, 2016.

(30) Foreign Application Priority Data
Nov. 12, 2015 (JP) 2015-222252

(51) Int. Cl. C03C 17/34; C03C 15/00; C03B 23/025; C03C 21/00; G09F 9/35; G02F 1/1333

(52) U.S. Cl. CPC C03C 17/34; C03C 15/00; C03B 23/025; C03C 21/002; G09F 9/35; G02F 1/133308; G02F 2001/133331; C03C 2217/73; C03C 2217/76; B60Y 2400/92; G02F 2001/133334; G02F 2001/13332; C03C 2218/119

(57) ABSTRACT

Provided is a print layer-attached plate including a plate having a first main surface and a second main surface, and a print layer provided on the first main surface, in which the first main surface at least partially includes a region formed of a recessed and projected layer having an arithmetic average surface roughness Ra of 4 nm or more and 1,000 nm or less, and the print layer is formed so as to cover at least a part of the region.

### TECHNICAL FIELD

The present invention relates to a print layer-attached plate, a display device using the same, and a functional layer-attached glass for in-vehicle display devices.

### BACKGROUND ART

Display devices such as liquid crystal display has been used in personal digital assistants such as a mobile phone and in panel displays. Those display devices are constituted of a display panel such as a liquid crystal panel displaying an image, a backlight irradiating the display device with illumination light, and the like. In recent years, a protective member is arranged on the front surface of a display panel in order to reduce external light reflection or to protect the display panel from external shock.

Conventionally, illumination light from the backlight has sometimes leaked outside the display panel, and the illumination light leaked has sometimes leaked to the side of a user through a gap between the display panel and its housing case. There is a problem that contrast of the display panel is difficult to be formed by the leaked illumination light to deteriorate visibility. For this reason, a print layer is provided on the surface at the side of the display panel of the protective member so as to surround a display region of the display panel. The print layer is formed by repeatedly coating with a coating material, thereby increasing light-shielding properties.

However, the conventional protective covers described in Patent Literature 1 and the like sometimes cause peeling and chipping of a print layer during packing and carrying steps for shipment, during an assembling step of the display devices, and the like. Particularly, there has been a problem that peeling and chipping from the outer periphery of the print layer are likely to occur. Furthermore, in the case where a print layer is provided on a glass having a bent part, the glass having a bent part is sometimes bent in a step of bonding to a display panel. In this case, there has been a problem that the print layer is easy to peel and chip.

### CITATION LIST

### Patent Literature

Patent Literature 1: JP-A 2011-7830

### SUMMARY OF INVENTION

### Technical Problem

The present invention has been made in view of the above-described problems, and an object thereof is to provide a print layer-attached plate that is difficult to peel and chip, a display device having the same, and a functional layer-attached glass for in-vehicle display devices.

### Solution to Problem

The print layer-attached plate of the present invention is a print layer-attached plate containing a plate having a first main surface and a second main surface, and a print layer provided on the first main surface, in which the first main surface at least partially has a region formed of a recessed and projected layer having an arithmetic average surface roughness Ra of 4 nm or more and 1,000 nm or less, and the print layer is formed so as to cover at least a part of the region.

According to the present invention, an ink used in the print layer enters a recessed and projected structure of the recessed and projected layer, and the print layer is strongly bonded to the recessed and projected layer. Accordingly, the print layer is difficult to peel and chip.

In a preferred embodiment of the present invention, the plate has a bent part.

In the case where a print layer-attached plate is manufactured by using a plate having a bent part, the plate is sometimes bent, for example, when stuck to a display panel, from the balance with the forming accuracy, and the print layer is easy to generate peeling and chipping. In this preferred embodiment of the present invention, the print layer is strongly bonded to the plate even under such a situation, and the print layer is difficult to peel and chip.

In a preferred embodiment of the present invention, the plate has a flat part and a bend part.

In the case where a print layer-attached plate is manufactured by using a plate having a flat part and a bent part, a connecting part between the flat part and the bent part is not unequivocally determined due to a margin of error in the forming accuracy. For this reason, in the case where a print layer-attached plate is manufactured by using such a plate and stuck to a display panel, the plate is sometimes bent for positioning. In the preferred embodiment of the present invention, because the print layer is strongly bonded to the plate even under such a situation, the print layer is difficult to peel and chip.

In a preferred embodiment of the present invention, the print layer is provided on the periphery on the first main surface.

According to this preferred embodiment of the present invention, the print layer is present on the periphery of the first main surface of the plate, and therefore a display panel can be arranged on the central part free of the print layer. When a display panel has been visually recognized from the side of a user, wirings and the like of a display panel are shielded with the print layer, resulting in excellent appearance.

In a preferred embodiment of the present invention, the recessed and projected layer is provided on the bent part.

In the case of the print layer-attached plate having a bent part, the bent part is sometimes bent in a sticking step to a display panel, and the like. According to this preferred embodiment of the present invention, the print layer is difficult to peel and chip even in such a case.

In a preferred embodiment of the present invention, the recessed and projected layer is provided on the flat part.

In the case of the print layer-attached plate having a flat part and a bent part, the flat part is sometimes bent in a sticking step to a display panel, and the like. According to this preferred embodiment of the present invention, the print layer is difficult to peel and chip even in such a case.

In a preferred embodiment of the present invention, an antiglare layer is provided at the second main surface side.

According to this preferred embodiment of the present invention, even when the print layer-attached plate is stuck to a display panel to form a display device as a final product and used in a car and the like, glare of external light reflected on the second main surface side of the plate does not annoy and good visibility can be secured.

In a preferred embodiment of the present invention, an antireflective layer is provided at the second main surface side.

According to this preferred embodiment of the present invention, even when a display device as a final product containing the print layer-attached plate stuck to a display panel is used in a car and the like, reflection by external light reflected on the second main surface side of the plate can be reduced and good visibility can be secured.

In a preferred embodiment of the present invention, a water and oil repellent layer is provided at the second main surface side.

In the case where a display device with a touch sensor incorporating the print layer-attached plate is used in a car and the like, a user frequently touches the second main surface side of the plate. According to this preferred embodiment of the present invention, finger marks are difficult to leave thereon and good visibility can be secured.

In a preferred embodiment of the present invention, an antifogging layer is provided at the first main surface side.

According to this preferred embodiment of the present invention, in the case where a display device as a final product containing the print layer-attached plate stuck to a display panel is used in a car and the like, even though a part of the print layer-attached plate is brought into contact with cold air of an air conditioner, fogging and dew condensation are not generated and good visibility can be secured.

In a preferred embodiment of the present invention, the plate is formed of a glass.

According to this preferred embodiment of the present invention, glass has high strength and has excellent texture. Therefore, the print layer-attached plate having both high strength and excellent texture can be obtained.

In a preferred embodiment of the present invention, the glass is a chemically strengthened glass.

According to this preferred embodiment of the present invention, in the case where a chemically strengthened glass is used as the plate, even though relatively thin glass is used, excellent strength and scratch resistance can be achieved.

In a preferred embodiment of the present invention, the print layer-attached plate is used as a cover for display devices.

According to this preferred embodiment of the present invention, in the case where the print layer-attached plate of the present invention is used as a cover for display devices, the print layer is difficult to peel and chip in, for example, handling when attaching to a display device, and as a result, productivity of a product can be improved.

In a preferred embodiment of the present invention, a display device contains the above-described cover for display devices, a frame supporting the print layer-attached plate, a display panel, and an adhesive layer sticking the print layer-attached plate to the display panel.

According to this preferred embodiment of the present invention, the print layer is difficult to peel. As a result, durability of the display device having the print layer-attached plate is improved.

The functional layer-attached glass for in-vehicle display devices of the present invention contains a plate having a first main surface and a second main surface, and a functional layer provided on the first main surface, in which the first main surface at least partially has a region formed of a recessed and projected layer having an arithmetic average surface roughness Ra of 4 nm or more and 1,000 nm or less, and the functional layer is formed so as to cover at least a part of the region.

According to the present invention, the functional layer such as a print layer or an adhesive layer enters a recessed and projected structure of the recessed and projected layer, and the functional layer is strongly bonded to the recessed and projected layer. In in-vehicle display devices, durability durable to long-term use is required. According to the present invention, the functional layer is difficult to peel and chip, and long-term durability can be realized.

### Advantageous Effects of Invention

According to the present invention, a print layer-attached plate that is difficult to peel and chip, a display device having the same, and a functional layer-attached glass for in-vehicle display devices can be provided.

### BRIEF DESCRIPTION OF DRAWINGS

FIG. 1 includes (a) of FIG. 1 being a perspective view illustrating the overall structure of the print layer-attached plate according to the first embodiment of the present invention, and (b) of FIG. 1 being a cross-sectional view viewed from the I-I arrow.

(a) to (c) of FIG. 2 are perspective views of the print layer-attached plates according to the modification examples of the first embodiment of the present invention.

(a) to (d) of FIG. 3 are perspective views of the print layer-attached plates according to the second embodiment of the present invention.

(a) to (d) of FIG. 4 are perspective views of the print layer-attached plates according to the third embodiment of the present invention.

(a) to (d) of FIG. 5 are perspective views of the print layer-attached plates according to the modification examples of the third embodiment of the present invention.

(a) to (d) of FIG. 6 are perspective views of the print layer-attached plates according to the fourth embodiment of the present invention.

(a) to (d) of FIG. 7 are perspective views of the print layer-attached plates according to the fifth embodiment of the present invention.

(a) to (d) of FIG. 8 are views explaining a method for partially forming a recessed and projected layer by a chemical method or a physical method.

(a) to (c) of FIG. 9 are views explaining a method for partially forming a recessed and projected layer by a thermal method.

(a) to (c) of FIG. 10 are views explaining a method for manufacturing a display device using the print layer-attached plate according to the embodiment.

(a) and (b) of FIG. 11 include (a) of FIG. 11 being a perspective view of a plate having a flat part and a bent part, and (b) of FIG. 11 being a cross-sectional view viewed from the II-II arrow, and (c) of FIG. 11 illustrates a cross-sectional view of a curved plate having a curvature being not 0 in whole.

### DESCRIPTION OF EMBODIMENTS

The embodiments of the present invention will be described in detail below based on the drawings. The present invention is not limited to each embodiment described below. Modifications, improvements and the like within the scope capable of achieving the object of the present invention are included in the present invention.

### Structure of Print Layer-Attached Plate

### First Embodiment

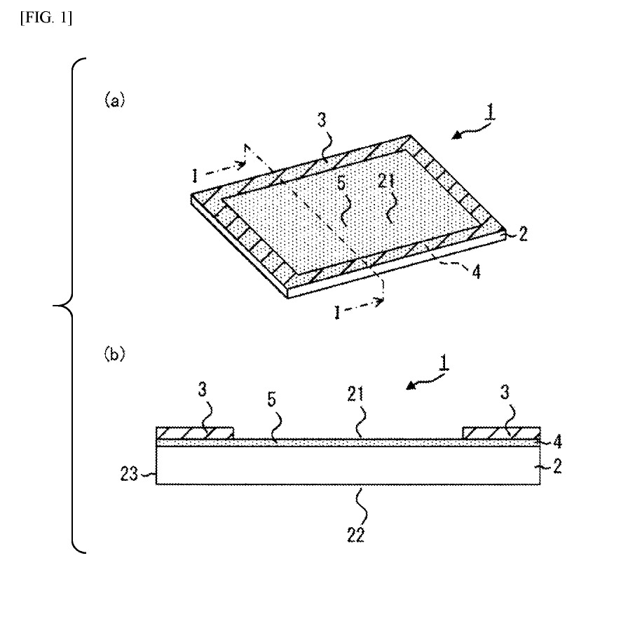

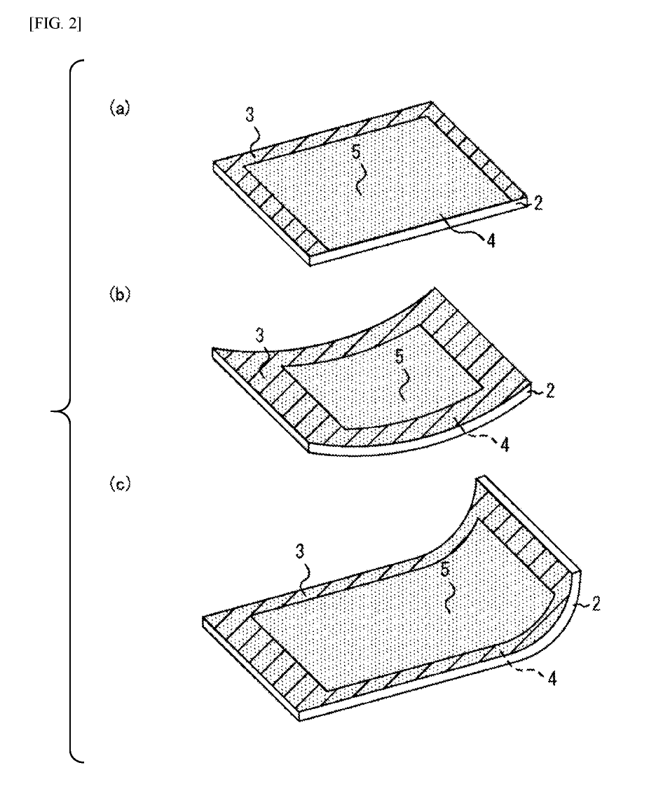

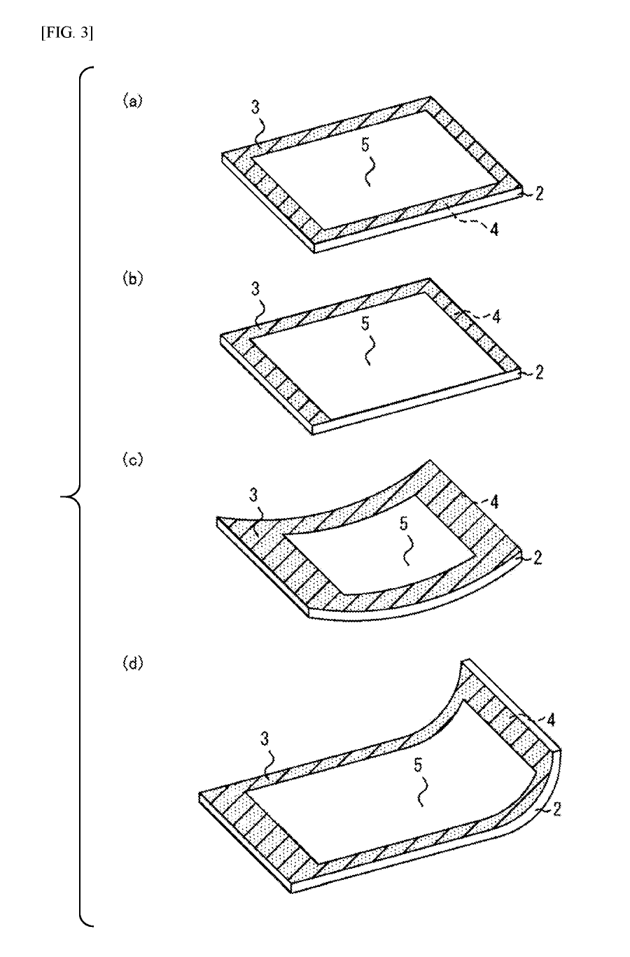

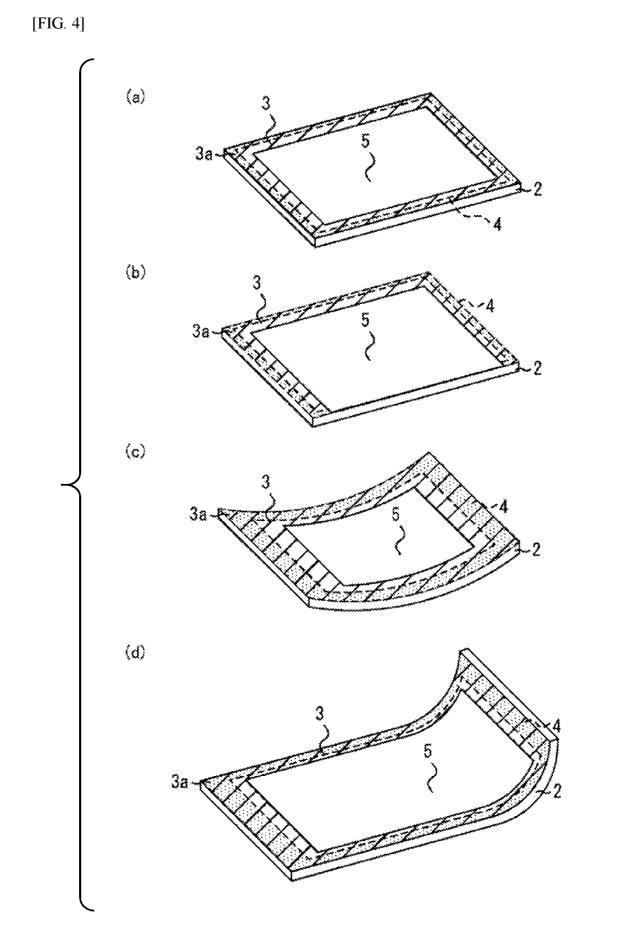

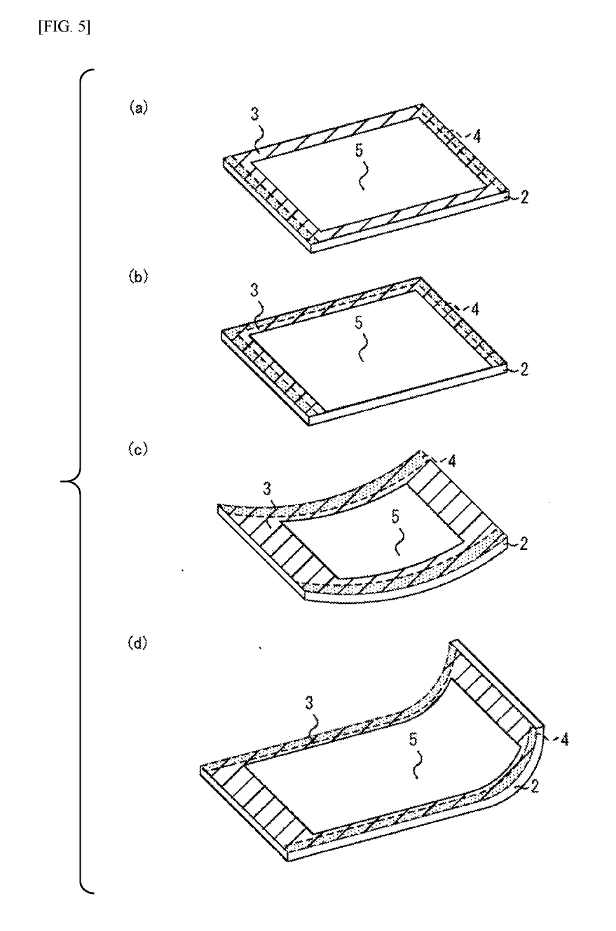

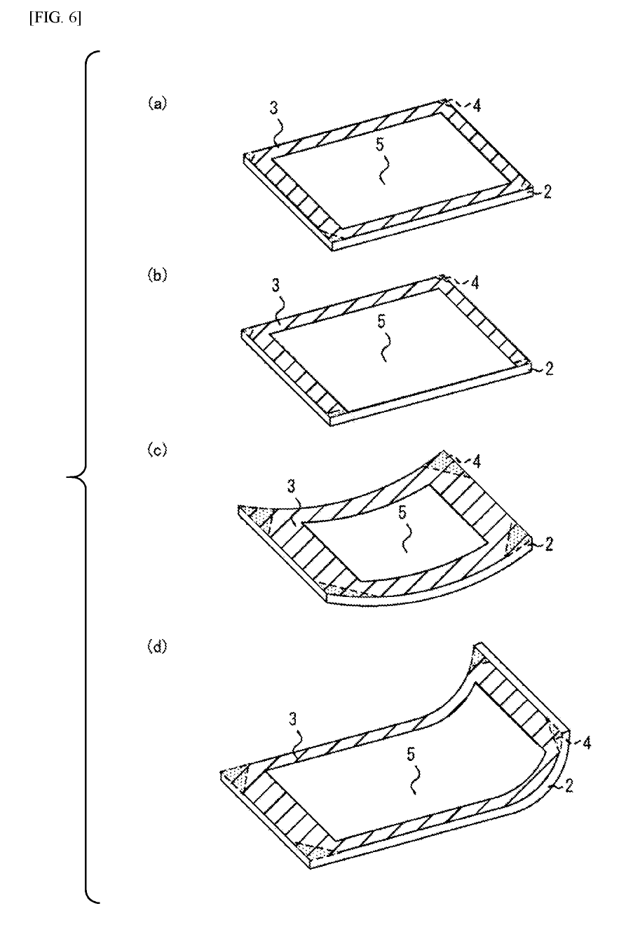

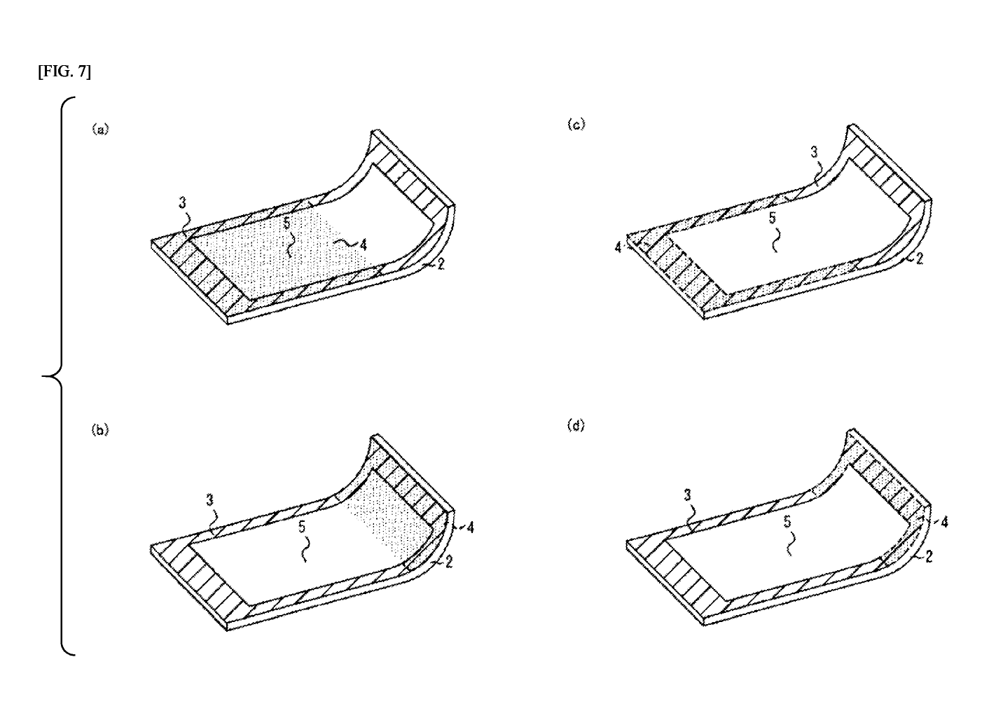

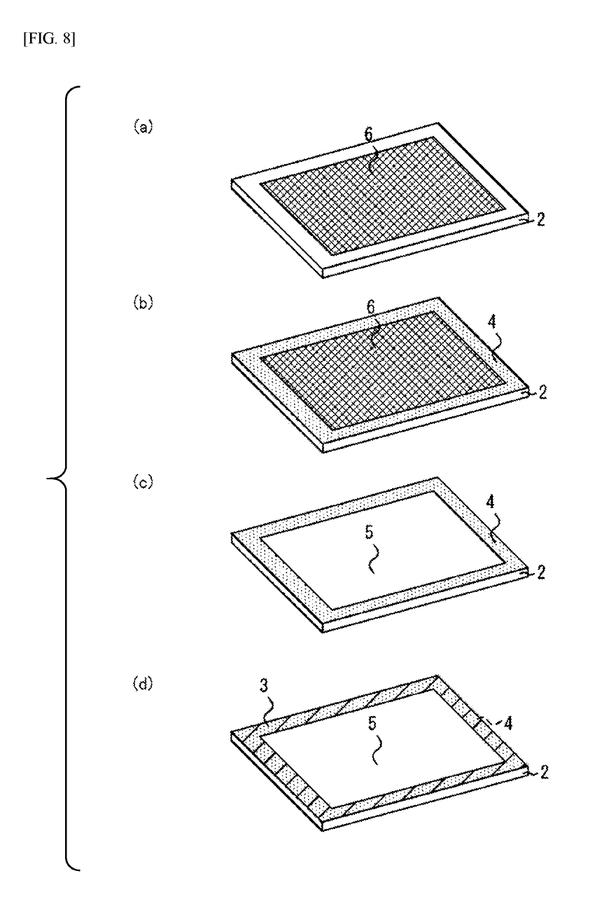

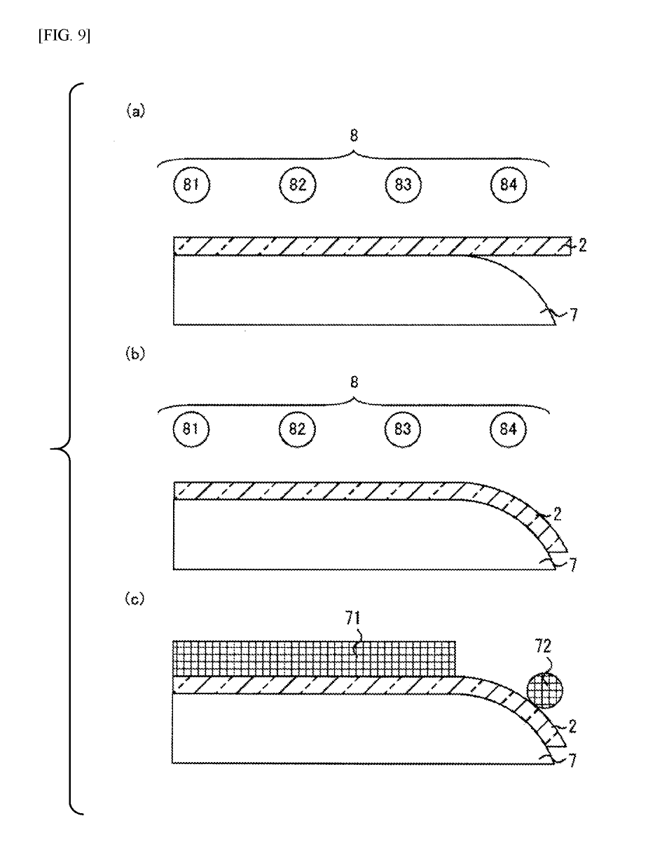

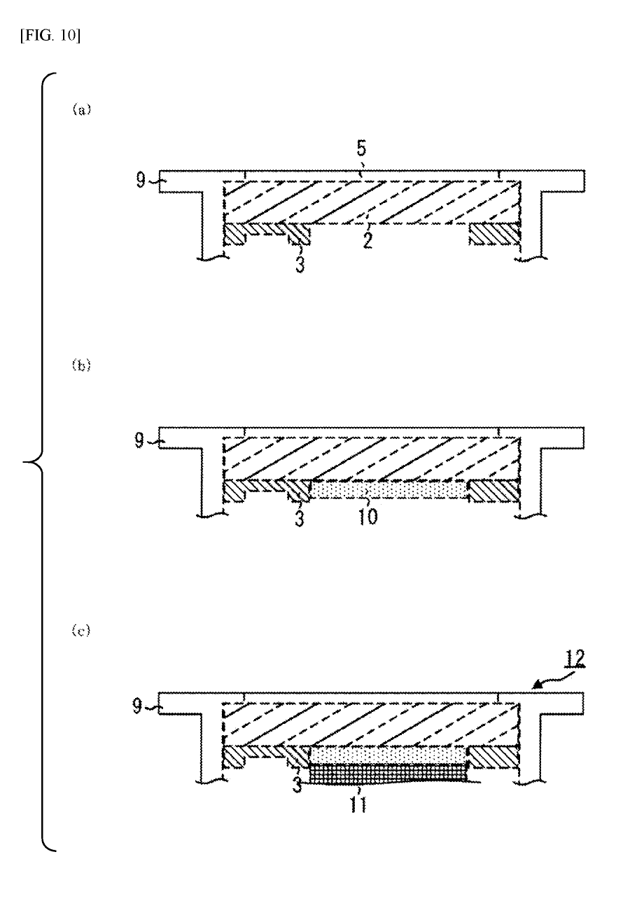

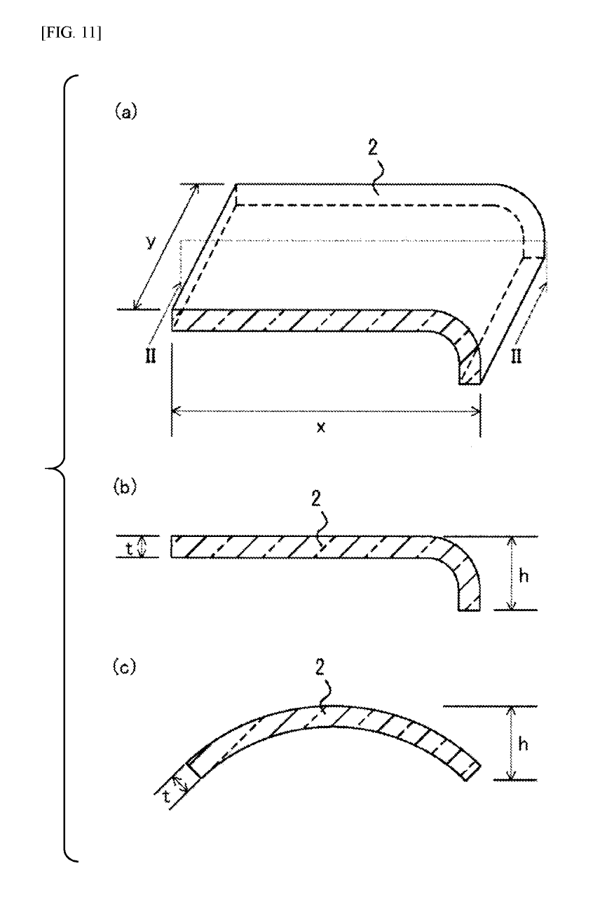

FIG. 1 includes (a) being a perspective view illustrating the overall structure of the print layer-attached plate according to the first embodiment of the present invention, and (b) being a cross-sectional view viewed from the I-I arrow. A print layer-attached plate 1 of the present embodiment contains a plate 2 and a print layer 3.

The plate 2 has a first main surface 21, a second main surface 22 and an end face 23. A region formed of a recessed and projected layer 4 is present on the entire surface of the first main surface 21, and the print layer 3 is formed on the region formed of the recessed and projected layer 4.

The recessed and projected layer 4 has a recessed and projected structure having an arithmetic average surface roughness Ra of 4 nm or more and 1,000 nm or less. Accordingly, when the print layer 3 is formed on the region formed of the recessed and projected layer 4, an ink used in the print layer 3 enters a recessed and projected structure of the recessed and projected layer 4, and the print layer 3 is strongly bonded to the recessed and projected layer 4. Therefore, the print layer-attached plate 1 in which the print layer 3 is difficult to peel and chip is formed.

The arithmetic average surface roughness Ra of the recessed and projected layer 4 is more preferably 10 nm or more, and still more preferably 50 nm or more. By this, the print layer 3 is further strongly bound to the recessed and projected layer 4, and is difficult to peel and chip. In addition, the arithmetic average surface roughness Ra of the recessed and projected layer 4 is more preferably 800 nm or less, and still more preferably 500 nm or less. By this, when a user has visually recognized the region of the recessed and projected layer 4 on which the print layer 3 is not formed, the aesthetic appearance can be maintained without giving white cloudy impression.

The recessed and projected layer 4 provided with the recessed and projected structure in the range described above allows the production of the print layer-attached plate 1 that is difficult to peel and chip and has excellent aesthetic appearance.

The arithmetic average surface roughness Ra is measured by the method described in JIS B0601: 2001 (ISO 4287: 1997).

The print layer 3 is provided on the region that is the periphery of the first main surface 21 of the plate 2 and includes the recessed and projected layer 4. The print layer 3 is formed by the application of a plurality of layers such that the desired function such as light-shielding properties is obtained. A region other than the print layer 3 on the plate 2 constitutes a display region 5.

A display panel such as a liquid crystal panel is arranged on the display region 5 when manufacturing a display device as a final product. The display panel includes wirings, circuits and the like for driving. When the display panel is visually recognized through the plate 2, wirings, circuits and the like are visually recognized, and this impairs the aesthetic appearance. Accordingly, the print layer 3 is provided on the periphery of the plate 2 and thus, wirings, circuits and the like arranged in the vicinity of the outer circumference can be shielded, thereby increasing the aesthetic appearance.

The periphery means a belt-shaped region having a predetermined width toward a central part of the plate 2 from the outer circumference of the plate 2. The print layer 3 may be provided on the entire periphery of the first main surface 21 as illustrated in (a) of FIG. 1, and may be provided on a part of the periphery as illustrated in (a) of FIG. 2. The width over the entire periphery of the print layer 3 may be the same and may be different. The thickness over the entire periphery of the print layer 3 may be the same and may be different.

The plate 2 is not limited to a plate having only a flat surface, and may be a curved plate in which the curvature is not 0 in whole as illustrated in (b) of FIG. 2, and a plate having a flat part and a bent part as illustrated in (c) of FIG. 2. Such a curved substrate and the like have somewhat a non-uniformity depending on processing accuracy in forming, and it is assumed that a load is applied to a bent part when combining in a display device. For this reason, in the print layer-attached plate 1 of this embodiment, the print layer is difficult to peel and chip even though a load is applied, and this is very effective.

In this embodiment, the recessed and projected layer 4 is formed on the entire surface of the first main surface, and the recessed and projected layer 4 is also present at the first main surface 21 side of the display region 5. As described above, a display panel is arranged on the display region 5 by using an adhesive or the like, the adhesive or the like enters a recessed and projected structure of the recessed and projected layer 4, and the adhesive or the like is strongly bonded to the recessed and projected layer 4. Therefore, a display panel is difficult to peel, and high durability display device can be obtained.

### Second Embodiment

The second embodiment has the same structure as in the first embodiment, except that a formation range of the region formed of the recessed and projected layer 4 differs therefrom. In the description of the second embodiment, the same reference numerals and signs are allotted to the same structure as in the first embodiment, and the description thereof is omitted.

(a) to (d) of FIG. 3 illustrate perspective views of the print layer-attached plates 1 according to the second embodiment. In this embodiment, the recessed and projected layer 4 is formed only on the first main surface 21 of the plate 2 corresponding to a portion on which the print layer 3 is formed.

Accordingly, when the print layer 3 is formed on the region formed of the recessed and projected layer 4, an ink used in the print layer 3 enters a recessed and projected structure of the recessed and projected layer 4, and the print layer 3 is strongly bonded to the recessed and projected layer 4. Therefore, the print layer-attached plate 1 in which the print layer 3 is difficult to peel and chip is obtained. Furthermore, because the recessed and projected layer 4 is not formed on the display region 5, visibility is further excellent. The region formed of the recessed and projected layer 4 may be provided on the entire periphery of the first main surface 21, and may be provided on a part of the periphery. The width of the region formed of the recessed and projected layer 4 may be the same or different.

### Third Embodiment

The third embodiment has the same structure as in the first embodiment and the second embodiment, except that a formation range of the region formed of the recessed and projected layer 4 differs therefrom. In the description of the third embodiment, the same reference numerals and signs are allotted to the same structure as in the first embodiment, and the description thereof is omitted.

(a) to (d) of FIG. 4 illustrate perspective views of the print layer-attached plates 1 according to the third embodiment. In this embodiment, the region formed of the recessed and projected layer 4 is formed only on the first main surface 21 of the plate 2 corresponding to an outer peripheral portion 3a of the print layer 3.

When shipping the print layer-attached plate 1, a film or the like is adhered to both main surfaces of the print layer-attached plate 1. The film is peeled in a shipping destination, and the print layer-attached plate 1 is then incorporated into a production line. Since the print layer 3 is strongly bonded to the recessed and projected layer 4, peeling and chipping of the print layer 3 when peeling the film can be prevented. To prevent such a peeling and chipping, the region formed of the recessed and projected layer 4 only has to be formed only on the first main surface 21 of the plate 2 corresponding to the outer peripheral portion 3a of the print layer 3, and the region formed of the recessed and projected layer 4 can be formed inexpensively and easily as compared with the first embodiment and the second embodiment.

The outer peripheral portion 3a of the print layer 3 is preferably a region surrounded by an outer peripheral edge of the print layer 3 and a virtual line corresponding to more than 0% and 80% or less of the width of the print layer 3 toward an inner peripheral side from the outer peripheral edge. Accordingly, in the case where the print layer-attached plate 1 of the present invention is used in a display device, peeling and chipping of the print layer 3 can be suppressed while securing good visibility. The outer peripheral portion 3a of the print layer 3 is more preferably a region surrounded by the outer peripheral edge of the print layer 3 and a virtual line corresponding to more than 5% and 70% or less of the width of the print layer 3 toward an inner peripheral side from the outer peripheral edge, and still more preferably a region surrounded by a virtual line corresponding to more than 10% and 60% or less of the width of the print layer 3.

Perspective views of the print layer-attached plate 1 according to modification examples of the third embodiment are illustrated in (a) to (d) of FIG. 5.

The region formed of the recessed and projected layer 4 may be provided on the entire periphery of the first main surface 21, and may be provided on a part of the periphery as illustrated in FIG. 5. The width of the region formed of the recessed and projected layer 4 may be the same or different.

### Fourth Embodiment

The fourth embodiment has the same structure as in the first embodiment to the third embodiment, except that a formation range of the region formed of the recessed and projected layer 4 differs therefrom. In the description of the fourth embodiment, the same reference numerals and signs are allotted to the same structures as in the first embodiment, and the description thereof is omitted.

(a) to (d) of FIG. 6 illustrate perspective views of the print layer-attached plates 1 according to the fourth embodiment. In this embodiment, the region formed of the recessed and projected layer 4 is formed on the first main surface 21 of the plate 2 forming a polygonal shape in a planar view and in the vicinity of apexes of the polygonal shape.

When shipping the print layer-attached plate 1, a film or the like is adhered to both main surfaces of the print layer-attached plate 1. The film is peeled in a shipping destination, and the print layer-attached plate 1 is then incorporated into a production line. In this embodiment, an ink used in the print layer 3 enters a recessed and projected structure and the print layer 3 is strongly bonded to the recessed and projected layer 4. Therefore, peeling and chipping of the print layer 3 from the vicinity of each apex can be prevented when peeling the film. To prevent such a peeling and chipping, the region formed of the recessed and projected layer 4 only has to be formed in the vicinity of apexes of the plate 2 having a polygonal shape in a planar view, and the region formed of the recessed and projected layer 4 can be formed inexpensively and easily as compared with the first embodiment to the third embodiment.

The region formed of the recessed and projected layer 4 formed in the vicinity of apexes of a polygonal shape can be formed in a triangular shape in such a manner that its one apex coincides with one apex of the polygonal shape, as illustrated in FIG. 6. However, it may be a sector shape and may be a square shape, and the shape is not particularly limited.

### Fifth Embodiment

The fifth embodiment has the same structure as in the first embodiment to the fourth embodiment, except that a formation range of the region formed of the recessed and projected layer 4 differs therefrom. In the description of the fifth embodiment, the same reference numerals and signs are allotted to the same structure as in the first embodiment, and the description thereof is omitted.

(a) to (d) of FIG. 7 illustrate perspective views of the print layer-attached plates 1 according to the fifth embodiment. In this embodiment, in the plate 2 having a flat part and a bent part, the region formed of the recessed and projected layer 4 is formed on the first main surface 21 in the flat part or the bent part.

When shipping the print layer-attached plate 1, a film or the like is adhered to both main surfaces of the print layer-attached plate 1. The film is peeled in a shipping destination, and the print layer-attached plate 1 is then incorporated into a production line. An ink used in the print layer 3 enters a recessed and projected structure and the print layer 3 is strongly bonded to the recessed and projected layer 4. Therefore, peeling and chipping of the print layer 3 when peeling the film can be prevented.

Such a curved substrate and the like have somewhat a non-uniformity depending on processing accuracy in forming, and it is assumed that a load is applied to a bent part when combining in a display device. In the case where the region formed of the recessed and projected layer 4 is formed on the bent part as illustrated in (b) and (d) of FIG. 7, the print layer-attached plate 1 of this embodiment can secure good visibility in the display region 5, and the print layer 3 is difficult to peel and chip even though a load is applied.

### Formation of Region Formed of Recessed and Projected Layer 4

The recessed and projected layer 4 may be formed by deforming the plate 2 itself, and may be separately formed on the plate 2.

As a method for forming the recessed and projected layer 4, use can be made of, for example, a method of forming a recessed and projected shape having a desired surface roughness by applying a surface treatment to at least a part of the first main surface 21 of the plate 2 by a chemical method or by a physical method. As the treatment method, a coating liquid may be applied or sprayed to the first main surface 21 of the plate 2 to form a recessed and projected structure on the plate 2.

Furthermore, a recessed and projected structure may be formed on at least a part of the first main surface 21 of the plate 2 by a thermal method.

The recessed and projected structure may be formed also on at least a part of the second main surface 22.

The method for forming a recessed and projected structure by a chemical method specifically includes a method of performing frosting. In the frosting, for example, the plate 2 as a material to be treated is dipped in a mixed solution of hydrogen fluoride and ammonium fluoride and etched.

Examples of the method for forming a recessed and projected structure by a physical method include a so-called sand blasting of spraying crystalline silicon dioxide powder, silicon carbide powder or the like to at least one main surface of the plate 2 by pressurized air, and a method of polishing at least one main surface of the plate 2 by using a brush having crystalline silicon dioxide powder, silicon carbide powder or the like attached thereto and wetted with water.

Above all, the frosting which is a chemical method, is preferably used because microcracks are less liable to be generated on the surface of a material to be treated and strength of the plate 2 is less liable to be reduced.

Furthermore, it is preferred to conduct an etching treatment in order to adjust surface shape of the recessed and projected layer 4 of the plate 2 having been subjected to a forming method of a recessed and projected structure. As the etching treatment, for example, use can be made of a method of dipping the plate 2 in an etching solution that is an aqueous solution of hydrogen fluoride to perform etching chemically. The etching solution may contain an acid such as hydrochloric acid, nitric acid or citric acid, other than hydrogen fluoride. In the case where those acids are contained in the etching solution, local generation of precipitates due to the reaction of cationic components such as Na ions and K ions contained in the plate 2 with hydrogen fluoride can be suppressed. In addition to this, an etching treatment can be made to uniformly proceed in a treated surface

In the case of conducting the etching treatment, the etching amount can be controlled by controlling a concentration of an etching solution, dipping time of the plate 2 in the etching solution, and the like, whereby a recessed and projected structure of the recessed and projected layer 4 of the plate 2 can be formed and can be controlled to a desired surface roughness. In the case where the recessed and projected structure is formed by a physical surface treatment such as sand blasting, cracks are sometimes generated. However, such cracks can be removed by the etching treatment. In addition, glare of the plate 2 having the recessed and projected structure formed thereon can be suppressed by the etching treatment.

Arithmetic average surface roughness Ra of the recessed and projected layer 4 is 4 nm or more, preferably 10 nm or more, and more preferably 50 nm or more. The arithmetic average surface roughness Ra of the recessed and projected layer 4 is 1,000 nm or less, preferably 800 nm or less, and more preferably 500 nm or less.

In the region formed of the recessed and projected layer 4, an average haze at a measurement site is preferably 40% or less, more preferably 30% or less, and still more preferably 20% or less. In the case where the haze value is 40% or less, deterioration of contrast can be sufficiently suppressed.

As the method for forming a recessed and projected structure by coating, use can be made of conventional wet coating methods (a spray coating method, an electrostatic coating method, a spin coating method, a dip coating method, a die coating method, a curtain coating method, a screen coating method, an inkjet method, a flow coating method, a gravure coating method, a bar coating method, a flexo coating method, a slit coating method, a roll coating method, etc.) and the like.

Above all, a spray coating method and an electrostatic coating method (electrostatic spraying method) are excellent methods for forming the recessed and projected structure. The recessed and projected structure can be formed by treating the plate 2 by a spray apparatus by using a coating liquid, and the recessed and projected layer 4 can be formed. According to these methods, the recessed and projected structure can be given to a desired site on the plate 2. Furthermore, surface roughness and the like of the recessed and projected structure can be changed in a wide range. The reason for this is that a recessed and projected shape necessary for obtaining required properties can be relatively easily formed by freely changing a coating amount and material constitution of the coating liquid. In the case of the plate 2 having a bent part, an electrostatic coating method is particularly preferred. According to the electrostatic coating method, a region formed of the recessed and projected layer 4 can be formed homogeneously on a flat part and a bent part, and aesthetic appearance is improved.

Examples of other method for forming the recessed and projected structure include transferring and molding, using a mold. In the case where the plate 2 is glass or the like, the recessed and projected structure can be given to at least one main surface of the glass used as the plate 2 by using a mold having a desired surface roughness at a desired position.

Examples of the material of the mold include stainless steel, carbon, SiC, cemented carbide (WC, etc.), and fused silica. To produce large-sized transferred and molded products, stainless steel and carbon are preferred from the standpoint of processability and the like. Carbon is more preferred from the standpoint of costs and handling due to weight and the like.

The recessed and projected layer 4 having the above-described recessed and projected structure can be formed by performing transferring and molding on the plate 2 by using such a mold,.

Here, of at least one main surface of the plate 2, the arithmetic average surface roughness of the portion contacting transferring and molding face of the mold reflects the arithmetic average surface roughness of the transferring and molding face of the mold and has approximately the same value. Therefore, the arithmetic average surface roughness of the surface of transferring and molding face of the mold is preferably 1,000 nm or less, more preferably 800 nm or less, and still more preferably 500 nm or less. When the transferring and molding are performed on the plate 2 by using such a mold, the recessed and projected structure of the mold can be reflected to the plate 2, and as a result, the recessed and projected layer 4 can be easily formed.

Polishing may be conducted after the transferring or forming of the plate 2 to obtain desired surface roughness of the recessed and projected layer 4. In this case, the arithmetic average surface roughness of the surface of the transferring face and molding face of the mold is preferably 20,000 nm or less, more preferably 10,000 nm or less, still more preferably 5,000 nm or less, and particularly preferably 2,000 nm or less. According to this, it is not necessary to control the surface roughness of the mold and it is not necessary to manage surface state of the mold.

In the case where at least one main surface of the plate 2 is subjected to the transferring and molding, as a forming method used, a desired forming method may be selected from a differential pressure forming method (e.g., a vacuum forming method or a pressure forming method), a self-weight forming method, a press forming method, and the like, depending on the shape of the glass structure 1 after forming.

The differential pressure forming method is a method of giving differential pressure to the front and back surfaces in the state where the plate 2 is softened, to make the plate 2 to fit to the mold to form into a desired shape. In the vacuum forming method, the plate 2 is placed on a predetermined mold according to a desired shape after forming, a clamp mold is set on the plate 2, and the periphery of the plate 2 is sealed. Thereafter, the pressure in a space between the mold and the plate 2 is reduced by a pump to give differential pressure to the front and back surfaces of the plate 2. In the pressure forming method, the plate 2 is placed on a predetermined mold according to a desired shape after forming, a clamp mold is set on the plate 2, and the periphery of the plate 2 is sealed. Thereafter, pressure is applied to the upper surface of the plate 2 by compressed air to give differential pressure to the front and back surfaces of the plate 2. The vacuum forming method and the pressure forming method may be combined with each other.

The self-weight forming method is a method of placing the plate 2 on a predetermined mold according to a desired shape after forming, softening the plate 2, making the plate 2 to fit to the mold by gravity, and forming into the desired shape. The press forming method is a method of placing the plate 2 between predetermined molds (lower mold and upper mold) according to a desired shape after forming, applying press load between the upper and lower molds in the state where the plate 2 is softened, making the plate 2 to fit to the molds, and forming into the desired shape.

Of the above-described forming methods, the differential pressure forming method and the self-weight forming method are particularly preferred. According to the differential pressure forming method, of the first main surface 21 and the second main surface 22 of the plate 2, forming can be performed without bringing the second main surface 22 into contact with a forming mold, and as a result, unevenness defects such as flaws and depressed areas can be reduced. In this case, it is preferred from the standpoint of improvement of visibility that the second main surface 22 is used as an outer surface of an assembly, that is, a face with which a user contacts in an ordinary use state.

Two or more forming methods of the above-described forming methods may be combined depending on the shape of the plate 2 after forming.

The method for forming a recessed and projected structure may be conducted in one kind alone and may be conducted by combining two or more kinds thereof. For example, the formation of a recessed and projected structure by an etching treatment, a spray method using a coating liquid, or the like is generally conducted alone, but they may be combined.

The region formed of the recessed and projected layer 4 may be partially formed on at least one main surface of the plate 2. (a) to (d) of FIG. 8 illustrate a method for partially forming the region formed of the recessed and projected layer 4. As illustrated in (a) of FIG. 8, the plate 2 having a desired shape and size is prepared, and a mask 6 is arranged on a region on which the region formed of the recessed and projected layer 4 is not formed. As the mask 6, use can be made of, for example, an etchant-resistant material such as a photosensitive organic material, particularly a resist or a resin that are a photosensitive resin material, a metal film, and ceramics, and the like, but is not particularly limited. As illustrated in (b) of FIG. 8, the area free of the mask 6 is treated with the above-described chemical treatment or physical treatment to form the recessed and projected layer 4. Thereafter, the mask 6 is removed, to thereby obtain the plate 2 having the region formed of the recessed and projected layer 4 partially formed thereon as illustrated in (c) of FIG. 8.

(a) and (b) of FIG. 9 illustrate a method for partially forming the region formed of the recessed and projected layer 4 by a thermal method. As illustrated in (a) of FIG. 9, in a forming apparatus containing a mold 7 having the above-described surface roughness and material and a heater 8, the plate 2 such as glass is arranged on the mold 7. The plate 2 is softened by increasing the temperature of the heater 8. Thereafter, when a part of the plate 2 is made to fit to the mold 7 by self-weight descending, the plate 2 having a bent part is obtained by a self-weight forming. In this case, pushers 71 and 72, and the like may be used to push against a flat part, a bend part or both. After cooling, the plate 2 having the recessed and projected layer 4 partially formed thereon is obtained.

In the case of glass, the temperature of the heater is increased to preferably 600 to 900° C., and more preferably 650 to 850° C. In the case where there are a plurality of heaters such as local heaters 81 to 84, the preset temperature may be changed, respectively. For example, the preset temperature may be increased in the order of the local heaters 82, 83 and 84 so as to be higher than the preset temperature of the local heater 81. This can allow the formation of the recessed and projected layer 4 only on the bent part without forming the recessed and projected layer 4 on the flat part greatly affecting visibility of a display device.

The print layer-attached plate 1 of the present invention can be obtained by forming the print layer 3 on the region formed of the recessed and projected layer 4 in the plate 2 having the region formed of the recessed and projected layer 4 partially formed thereon as described above.

A perspective view of the plate 2 having a flat part and a bent part obtained by forming is illustrated in (a) of FIG. 11, and a cross-sectional view thereof is illustrated in (b) of FIG. 11. The plate 2 includes a parameter of bending depth h, in addition to horizontal dimension x, vertical dimension y, and plate thickness t. The bending depth h is preferably 5 mm or more, more preferably 10 mm or more, and still more preferably 20 mm or more. There have been problems that as the bending depth h increases, it becomes difficult to improve forming accuracy, the case where the plate 2 with a print layer having the print layer 3 formed thereon is bent in the post steps increases, and peeling and chipping are generated in the print layer 3. According to the present method, when the print layer 3 is formed on such a plate 2, the print layer-attached plate 1 in which the print layer 3 is difficult to peel and chip can be formed.

(c) of FIG. 11 illustrates a cross-sectional view of the plate 2 free of a flat part and having only a bent part. The bending depth h in this case means a distance between a line segment connecting two edges of the plate 2 and a tangent parallel thereto of the bottom of the plate 2.

Other parameters x, y and t are not particularly limited. The thickness t is preferably formed by using a flat plate having a thickness described hereinafter, and is nearly constant thickness tin the overall region of the plate 2. However, the thickness may be partially changed, and the thickness t may be changed in the overall region of the plate 2.

A surface treatment step such as an antiglare layer, a processing step such as chamfering or cutting, a polishing step, and a strengthening step may be conducted before and after a printing step for forming the print layer 3. The order of the steps is not particularly limited, and appropriately selected.

The present invention is not limited to each embodiment described above, and modifications, improvements and the like within the scope capable of achieving the object of the present invention are included in the present invention.

### Modification Example

For the plate 2 in the present invention, plates having various shapes and formed of various materials can be used depending on the purpose of use. The plate is not limited to a plate-shaped substrate, and may be a film-shaped substrate. The material used only has to be transparent, and ordinary glasses, for example, inorganic glass or organic glass such as polycarbonate or acryl, can be used. Other synthetic resins can also be used.

In the case where inorganic glass is used, its thickness is preferably 0.5 mm or more and 5 mm or less. The glass having a thickness of the lower limit or more has high strength and has excellent texture, and as a result, a print layer-attached plate having both high strength and excellent texture can be obtained, which is a merit. The thickness is more preferably 0.7 mm or more and 3 mm or less, and still more preferably 1 mm or more and 3 mm or less.

Organic glass, synthetic resin and the like may be a laminate substrate regardless of different kind and the same kind, and various adhesive layers may be interposed therebetween.

In the plate 2 of the present invention, a surface treatment such as an anti-glare treatment (AG treatment), an anti-reflection treatment (AR treatment) and an anti-fingerprint treatment (AFP treatment) may be applied to the first main surface 21, the second main surface 22 or both. A primer treatment, an etching treatment or the like may be also applied in order to improve adhesiveness to the print layer.

The plate 2 of the present invention may be subjected to a processing treatment such as grinding and polishing, or chamfering by etching. The chamfering can generally perform R chamfering (processing glass edge into a semicircular state), C chamfering (treatment of obliquely cutting), and the like. In the case where glass is used as the plate 2, many cracks are generated in the edge of an untreated glass. The cracks affect strength of the glass. Cracks affecting strength of the glass can be removed by chamfering.

Polishing treatment may be applied to the plate 2 of the present invention. For example, when a suede pad is used and polishing slurry containing cerium oxide or colloidal silica is used as a polishing agent, flaws (cracks) present on the main surfaces of glass as the plate 2, and deflection and depressed area of the glass can be removed, and strength of the plate 2 is enhanced. The polishing may be conducted before or after chemical strengthening of the plate 2, but is preferably conducted after chemical strengthening. The reason for this is that in a strengthened glass plate having been subjected to a chemical strengthening by ion exchange, defects are generated on the main surfaces thereof. Furthermore, fine unevenness of at most about 1 μm may remain. When force acts on a glass plate, stress concentrates to a site having the above-described defects or fine unevenness present thereon, and the glass plate may break by force smaller than theoretical strength. For this reason, a layer (defective layer) having defects and fine unevenness existing on the main surfaces of the glass after a chemical strengthening is removed by polishing. The thickness of the defective layer having defects present thereon is generally 0.01 to 0.5 μm, although depending on the conditions of the chemical strengthening.

The maximum height roughness Rz of the recessed and projected layer 4 is preferably 0.2 to 5 μm, more preferably 0.3 to 4.5 μm, and more preferably 0.5 to 4 μm. In the case where the Rz is the lower limit value or more, the effect of suppressing peeling is exhibited, and in the case where the Rz is the upper limit value or less, the deterioration of contrast of an image can be suppressed when combined in a display device.

Additionally, as for the recessed and projected layer 4, for example, root means square roughness Rq is preferably 0.03 to 5 μm from the standpoints of roughness and finger slippage. Maximum cross-sectional height roughness Rt is preferably 0.05 to 5 μm from the standpoints of roughness and finger slippage. Maximum peak height roughness Rp is preferably 0.03 to 5 μm from the standpoints of roughness and finger slippage. Maximum valley depth roughness Rv is preferably 0.03 to 5 μm from the standpoints of roughness and finger slippage. Average length roughness Rsm is preferably 0.03 to 10 μm from the standpoints of roughness and finger slippage. Kurtosis roughness Rku is preferably 1 to 3 from the standpoint of tactile property. Skewness roughness Rsk is preferably −1 to 1 from the standpoint of uniformity of visibility, tactile property and the like. They are roughnesses based on a roughness curve R, but may be defined by waviness W or cross-sectional curve P correlating therewith, and there is no particular limitation.

The plate 2 in the present invention may be subjected to a strengthening treatment.

In the case where glass is used as the plate 2, an air cooling strengthening process (physical strengthening process) and a chemical strengthening process have been known as the representative strengthening process for forming a compressive stress layer. The air cooling strengthening process (physical strengthening process) is a method of rapidly cooling the main surfaces of a glass plate heated to the vicinity of a softening point, by air cooling or the like. The chemical strengthening process performs ion-exchanging at a temperature of a glass transition point or lower, by dipping the plate 2 in a potassium nitrate molten salt. It is a method by which alkali metal ions (typically Li ions and Na ions) having small ionic radius present on the main surfaces of the glass plate are substituted with alkali ions (typically Na ions or K ions for Li ions, and K ions for Na ions) having larger ionic radius. The chemical strengthening treatment can be carried out by conventional methods, and in general glass is dipped in a potassium nitrate molten salt. Potassium carbonate in an amount of about 10 mass % may be added to the molten salt and used. As a result, cracks and the like on a surface layer of the glass can be removed, and glass with high strength can be obtained. The chemical strengthening treatment is not limited to one time, and may be carried out two or more times, for example, under different conditions.

In the case where the above-described relatively thin inorganic glass is subjected to a strengthening treatment, a chemical strengthening treatment is appropriate.

In the glass as the plate 2 used in this embodiment, since the glass main surfaces are subjected to a strengthening treatment, glass with high mechanical strength can be obtained. In this embodiment, any strengthening method may be used, but in the case of obtaining a glass having small thickness and large compression stress (CS) value, strengthening is preferably performed by a chemical strengthening process.

Strengthening properties (strengthening profile) of a chemically strengthened glass are generally expressed by a compressive stress (CS) layer formed on the surface, depth of the compressive stress layer (DOL: Depth of Layer) and tensile stress (CT: Central Tension) formed in the inside. The case where glass as the plate 2 is a chemically strengthened glass is described below as an example.

In the glass as the plate 2 used in the present invention, a compressive layer is formed on the main surfaces of the glass. Compressive stress (CS) of the compressive stress layer is preferably 500 MPa or more, more preferably 550 MPa or more, still more preferably 600 MPa or more, and particularly preferably 700 MPa or more. As the compressive stress (CS) increases, mechanical strength of the strengthened glass increases. On the other hand, in the case where the compressive stress (CS) is too high, tensile stress inside the glass may excessively increase. Therefore, the compressive stress (CS) is preferably 1,800 MPa or less, more preferably 1,500 MPa or less, and still more preferably 1,200 MPa or less.

The depth (DOL) of the compressive stress layer formed on the main surface of the glass as the plate 2 is preferably 5 μm or more, more preferably 8 μm or more, and still more preferably 10 μm or more. On the other hand, in the case where DOL is too large, tensile stress inside the glass may excessively increase. Therefore, the depth (DOL) of the compressive stress layer is preferably 70 μm or less, more preferably 50 μm or less, still more preferably 40 μm or less, and typically 30 μm or less.

As a glass composition constituting the glass as the plate 2 of this embodiment, use can be made of, for example, soda lime glass, aluminosilicate glass, aluminoborosilicate glass, lithium disilicate glass, and the like. Example of the preferred composition ranges is described below. A glass containing, in mol % based on oxides, 50 to 79% of SiO₂, 0.5 to 25% of Al₂O₃, 0 to 10% of P₂O₅, 0 to 27% of Na₂O, 0 to 25% of Li₂O, the total of Na₂O and Li₂O being 4 to 27%, 0 to 10% of K₂O, 0 to 18% of MgO, 0 to 5% of ZrO₂, 0 to 5% of ZnO, 0 to 9% of CaO, 0 to 5% of SrO, 0 to 10% of BaO, 0 to 16% of B₂O₃, and 0 to 7% of a coloring component (metal oxides of Co, Mn, Fe, Ni, Cu, Cr, V, Bi, Se, Ti, Ce, Er, and Nd) is exemplified. The above ranges do not particularly limit the contents of the present invention.

The chemically strengthened glass of this embodiment preferably has at least one kind selected from the group consisting of sodium ions, silver ions, potassium ions, cesium ions, and rubidium ions on the surface thereof. By this, compressive stress is induced on the surface, and the glass is highly strengthened. Furthermore, in the case where silver nitrate is mixed with potassium nitrate when chemically strengthening, the glass as the plate 2 is ion-exchanged to have silver ions on the surface thereof, and antibacterial property can be given.

The print layer 3 in the present invention may be formed by various printing methods and inks (printing materials) depending on the uses. As the printing method, use can be made of, for example, spray printing, screen printing, inkjet printing, or the like. These methods can achieve satisfactory printing even on a plate having a large area. Particularly in spray printing, printing is easy to be performed on a plate having a bend part, and surface roughness of the printed surface is easy to be adjusted. On the other hand, in screen printing, desired printing pattern is easy to be formed on a wide plate such that an average thickness is uniform. A plurality of inks may be used, but the same ink is preferably used from the standpoint of adhesiveness of the print layer.

The thickness of the print layer 3 is preferably 10 μm or more, and more preferably 20 μm or more. By this, the print layer 3 that is difficult to see therethrough is formed, and high shielding properties can be achieved. The thickness of the print layer 3 is preferably 100 μm or less, and more preferably 80 μm or less. By this, a difference in level between the plate 2 and the print layer 3 can be reduced. Therefore, even when an adhesive layer is adhered to here, gaps and the like are less liable to remain, and as a result, productivity is improved and visibility is enhanced.

The ink forming the print layer 3 in the present invention may be an inorganic or an organic. The inorganic ink may be, for example, a composition containing at least one kind selected from SiO₂, ZnO, B₂O₃, Bi₂O₃, Li₂O, Na₂O, and K₂O, at least one kind selected from CuO, Al₂O₃, ZrO₂, SnO₂, and CeO₂, Fe₂O₃, and TiO₂.

As the organic ink, various printing materials obtained by dissolving a resin in a solvent can be used. For example, as the resin, use can be made of at least one selected from the group consisting of resins such as an acryl resin, a urethane resin, an epoxy resin, a polyester resin, a polyamide resin, a vinyl acetate resin, a phenol resin, an olefin resin, an ethylene-vinyl acetate copolymer resin, a polyvinyl acetal resin, natural rubber, a styrene-butadiene copolymer, an acrylonitrile-butadiene copolymer, polyester polyol, and polyether polyurethane polyol. As a solvent, use can be made of water, an alcohol, an ester, a ketone, an aromatic hydrocarbon solvent, and an aliphatic hydrocarbon solvent. For example, isopropyl alcohol, methanol, ethanol, and the like can be used as the alcohol, ethyl acetate can be used as the ester, and methyl ethyl ketone can be used as the ketone. Toluene, xylene, Solvesso 100 and Solvesso 150 manufactured by Exxon Mobil, and the like can be used as the aromatic hydrocarbon solvent, and hexane and the like can be used as the aliphatic hydrocarbon solvent. They are examples, and other various printing materials can be used. The organic printing material can be formed into a print layer by applying on a plate, and evaporating a solvent to form a layer of a resin.

The ink used in the print layer 3 may contain a colorant. For example, in the case where the print layer 3 is formed in black color, a black colorant such as carbon black can be used as the colorant. Other colorants with appropriate color can be used according to a desired color.

The print layer-attached plate 1 of the present invention can be used as, for example, a cover for display devices, such as a cover glass of panel displays such as a liquid crystal display, mobile instruments such as a smart phone, and the like. The print layer-attached plate 1 of the present invention is particularly suitable for use as a cover glass for in-vehicle display devices. The process for manufacturing in-vehicle display devices passes through steps of packing and shipping the print layer-attached plate 1, and mounting, assembling and carrying the print layer-attached plate 1 in display device assembling manufacturers. Conventionally, peeling and chipping of the print layer 3 have been easily generated by vibration when shipping, handling when assembling display devices, and the like. In the present invention, the print layer 3 and the plate 2 can be strongly fixed to each other, and occurrence probability of the above-described peeling and chipping can be greatly reduced.

A method for manufacturing a display device using the print layer-attached plate according to the embodiment of the present invention will be described below by referring to (a) of FIG. 10 to (c) of FIG. 10. In (a) of FIG. 10 to (c) of FIG. 10, the same reference numerals and signs are allotted to the same constituent elements as the constituent elements described above, and the descriptions thereof are omitted or simplified.

(a) of FIG. 10 is one example of a structure in which the print layer-attached plate 1 prepared above is arranged on a frame 9. The frame 9 may be fixed to the print layer-attached plate 1 by an adhesive layer or the like, and the print layer-attached plate 1 may be sandwiched by the frame 9 constituted of two kinds of structures and fixed thereto. The fixation is not particularly limited. Shape and material of the frame are also not particularly limited, and can be appropriately designed, selected and used.

(b) of FIG. 10 is one example of a structure in which the structure of the print layer-attached plate 1 and the frame 9, obtained in (a) of FIG. 10, is adhered with an adhesive layer 10. Regarding the shape and size of the adhesive layer 10, the size fitting to the display region 5 of the print layer-attached plate 1 is preferred, but the shape and size are not particularly limited.

The adhesive layer 10 is transparent like the plate 2, and refractive index difference between the plate 2 and the adhesive layer 10 is preferably small.

Example of the adhesive layer 10 includes a layer formed of a transparent resin obtained by curing a liquid curable resin composition. Examples of the curable resin composition include a photocurable resin composition and a thermosetting resin composition. Of those, the photocurable resin composition containing a curable compound and a photopolymerization initiator is preferred. The curable resin composition is, for example, applied by using a method such as die coater or roll coater to form a curable resin composition film.

The adhesive layer 10 may be an OCA film (OCA tape). In this case, the OCA film is adhered to the display region 5 at the side of the first main surface 21 of the print layer-attached plate 1.

The thickness of such an adhesive layer 10 is, for example, 5 to 400 μm, and preferably 50 to 200 μm. Storage shear modulus of the adhesive layer 10 is, for example, 5 kPa to 5 MPa, and preferably 1 MPa to 5 MPa.

The adhesive layer 10 is preferably formed on the recessed and projected layer 4 formed on the plate 2. By this, peeling of the functional layer including a resin layer such as an adhesive layer can be suppressed, and the plate can be strongly bonded to a material to be adhered, such as a display panel.

(c) of FIG. 10 is one example of a structure in which a liquid crystal panel 11 is adhered to the adhesive layer 10 of the structure obtained in (b) of FIG. 10. Accordingly, a display device 12 having the print layer-attached plate 1 of the present invention can be manufactured.

In manufacturing the display device 12 of the present invention, an assembly sequence is not particularly limited. For example, a structure containing the print layer-attached plate 1 and the adhesive layer 10 arranged thereon may be previously prepared, the structure may be arranged in the frame 9, and the liquid panel 11 may be then adhered thereto.

The constitution is not limited to the above constitution, and may further be provided with a touch sensor and the like. In the case of incorporating the touch sensor, the touch sensor is arranged on the display region 4 at the side of the first main surface 21 of the print layer-attached plate 1 through the adhesive layer 10, and the liquid crystal panel 11 is then arranged thereon through the adhesive layer 10.

### Uses

Uses of the print layer-attached plate 1 of the present invention are not particularly limited. Examples of the specific uses include in-vehicle parts (exterior members such as a headlight cover, a side mirror, a front transparent substrate, a side transparent substrate, and a rear transparent substrate, and interior members such as an instrument panel surface, a cover glass for in-vehicle display devices, and a decorative member), meters, building windows, show windows, building interior members, building exterior members, exterior members for electronic instruments (a laptop personal computer, a monitor, LCD, PDP, ELD, CRT, PDA, etc.), LCD color filters, touch panel substrates, mobile phone windows, organic EL light emitting element parts, inorganic EL light emitting element parts, fluorescent light emitting element parts, optical filters, lamps, lighting equipment covers, and the like.

### EXAMPLES

Examples of the present invention are described below. The present invention is not construed as being limited to the following Examples. Examples 1 and 2 are Invention Examples, and Example 3 is Comparative Example.

A glass plate that is a square plate glass (DRAGON TRAIL (registered trademark), manufactured by Asahi Glass Co., Ltd.) having a thickness of 2 mm and an arithmetic average surface roughness Ra of a main surface of 0.5 nm was used as the plate 2, and the respective print layer-attached glass plates were obtained by the following procedures. In the following description, one main surface of the glass plate is referred to as a first main surface (first surface) and the other main surface is referred to as a second main surface (second surface).

### Example 1

The glass plate was subjected to (1) formation of recessed and projected layer, (2) chemical strengthening treatment and alkali treatment, and (3) formation of print layer, in this order in the following procedures.

### (1) Formation of Recessed and Projected Layer

Recessed and projected layer was formed by frosting on the first main surface of the glass plate in the following procedures.

An acid-resistant protective film (hereinafter simply referred to as a “protective film”) was adhered to the main surface (second surface) at the side on which a recessed and projected layer is not formed of the glass plate. The glass plate was dipped in a 3 mass % hydrogen fluoride aqueous solution for 3 minutes to etch the glass plate to remove stains deposited on the surface of the first surface of the glass plate. Subsequently, the glass plate was dipped in a mixed aqueous solution of 15 mass % hydrogen fluoride and 15 mass % potassium fluoride for 3 minutes to perform frosting on the first surface of the glass plate. Thereafter, the glass plate was dipped in a 10 mass % hydrogen fluoride aqueous solution for 6 minutes to form a recessed and projected layer. Arithmetic average surface roughness Ra thereof was 120 nm.

### (2) Chemical Strengthening Treatment and Alkali Treatment

The protective film adhered to the glass plate was removed, and the glass plate was dipped for 2 hours in potassium nitrate salt melted by heating to 450° C. Thereafter, the glass plate was taken out of the molten salt, and gradually cooled to room temperature over 1 hour to conduct a chemical strengthening treatment. Accordingly, a chemically strengthened glass plate having a surface compressive stress (CS) of 730 MPa and a depth (DOL) of a surface stress layer of 30 μm was obtained.

The glass plate was further dipped in an alkali solution (tradename: SUNWASH TL-75, manufactured by Lion Corporation) for 4 hours to conduct an alkali treatment.

The arithmetic surface roughness Ra in this case did not almost change even after the chemical strengthening treatment and alkali treatment, and was 130 nm.

### (3) Formation of Print Layer

Four sides of the outer periphery of the first surface of the glass plate were printed in a black frame shape having a width of 2 cm to form a print layer. Black ink (tradename: GLSHF, manufactured by Teikoku Printing Inks Mfg. Co., Ltd.) was applied by a screen printing machine in a thickness of 5 μm, and dried by maintaining at 150° C. for 30 minutes. Printing was conducted so as to be a position of 0.1 mm from the edge of the glass plate in a planar view such that the outer periphery of the print layer was formed on the edge having been subjected to grinding treatment.

In this manner, the glass print layer-attached plate as illustrated in (a) of FIG. 1 was obtained.

### Example 2

Unlike Example 1, the glass plate was subjected to (2) chemical strengthening treatment and alkali treatment and (3) formation of print layer, in this order in the same manners, except that the process of (1) formation of recessed and projected layer differs.

### (1) Formation of Recessed and Projected Layer

Recessed and projected layer was formed on the first main surface of the glass plate by a thermal method in the following procedures.

A carbon-made mold having a curved part such that a bent part can be formed on a glass was used as a mold. The surface of the mold was polished such that an arithmetic average surface roughness Ra was 1,100 nm. The surface of the mold is brought into contact with the first surface of the glass when forming. Therefore, when the above-described recessed and projected structure has been provided on the surface of the mold, the mold surface has the function of giving a recessed and projected structure to the first surface of the glass in contact, thereby forming a recessed and projected layer.

After placing glass on the mold, the whole container storing the mold and glass was filled with an inert gas, and the ambient temperature was set to 800° C. By this, the glass was thermally softened and closely contacted so as to fit the mold surface to transfer the recessed and projected structure on the mold surface to the first surface of the glass. Thus, a glass having a recessed and projected layer formed thereon was obtained.

As a result of measuring the arithmetic surface roughness Ra of a bent part on the first surface of the glass after forming, it was 990 nm.

### Example 3

Unlike Example 1, the glass plate was subjected to (2) chemical strengthening treatment and alkali treatment and (3) formation of print layer, in this order in the same manners, except that (1) formation of recessed and projected layer was not conducted. In other words, a print layer is formed on the glass free of a recessed and projected layer, different from Example 1.

### Evaluation

The print layer-attached glass plates obtained in Example 1 to Example 3 were subjected to a print layer peeling test by the following method.

### Print Layer Peeling Test

Peeling resistance of the print layer was conducted as follows. A film used in shipping a print layer-attached glass plate was adhered to the first surface, and the film was peeled in a constant speed while maintaining a constant angle, and it was confirmed as to whether peeling or the like of the print layer was generated.

As the film, EC9000ALS (tradename, manufactured by Sumiron Co., Ltd.) containing a PET substrate and an acrylic paste as an adhesive attached thereto was used.

When the film was adhered to the first surface, attention was paid such that air gap does not remain between the first surface and the film, 0.1 MPa load was applied by a roller to closely contact, and the test was conducted.

The test was conducted such that the film was peeled in a rate of 50 mm/min and an angle between the print layer-attached glass plate and the film was 90° .

Test samples obtained by adhering the film to Example 1 to Example 3 were prepared every 20 samples, and the above-described test was conducted.

In Example 3, peeling or the like of the print layer was observed in 15 samples of 20 samples. The peeling was almost generated starting from the outer periphery of the print layer. On the other hand, in Example 1, peeling or the like of the print layer was observed in 3 samples of 20 samples, and in Example 2, it was observed in 1 sample of 20 samples. Thus, peeling or the like of the print layer was suppressed as compared with Example 3.

Furthermore, even though the print layer-attached glass plate having a bent part obtained in Example 2 was bent, the print layer was not peeled and not chipped, and had excellent durability.

From the above, it was understood that the print layer-attached glass plates of the Invention Examples exhibit excellent peeling resistance as compared with the print layer-attached glass plate of the Comparative Example.

Although the present invention has been described in detail and by reference to the specific embodiments, it is apparent to one skilled in the art that various modifications or changes can be made without departing the spirit and scope of the present invention. This application is based on Japanese Patent Application (No. 2015-222252) filed on Nov. 12, 2015, the disclosure of which is incorporated herein by reference.

### INDUSTRIAL APPLICABILITY

The present invention can be utilized in a protective member of in-vehicle display devices, displays and the like, in-vehicle interior members, exterior members for electronic instruments, and the like.

### Reference Signs List

1 Print layer-attached plate
2 Plate
21 First main surface
22 Second main surface
23 Edge
3 Print layer
4 Recessed and projected layer
5 Display region
6 Mask
7 Mold
8 Heater
81, 82, 83, 84 Local heaters
9 Frame
10 Adhesive layer
11 Liquid crystal panel (display panel)
12 Display device

1. A print layer-attached plate comprising a plate having a first main surface and a second main surface, and a print layer provided on the first main surface,
wherein the first main surface at least partially comprises a region formed of a recessed and projected layer having an arithmetic average surface roughness Ra of 4 nm or more and 1,000 nm or less, and the print layer is formed so as to cover at least a part of the region.

2. The print layer-attached plate according to claim 1,
wherein the plate comprises a bent part.

3. The print layer-attached plate according to claim 1,
wherein the plate comprises a flat part and a bend part.

4. The print layer-attached plate according to claim 1,
wherein the print layer is provided on a periphery on the first main surface.

5. The print layer-attached plate according to claim 2,
wherein the recessed and projected layer is provided on the bent part.

6. The print layer-attached plate according to claim 3,
wherein the recessed and projected layer is provided on the bent part.

7. The print layer-attached plate according to claim 3,
wherein the recessed and projected layer is provided on the flat part.

8. The print layer-attached plate according to claim 1, further comprising an antiglare layer at a side of the second main surface.

9. The print layer-attached plate according to claim 1, further comprising an antireflective layer at a side of the second main surface.

10. The print layer-attached plate according to claim 1, further comprising a water and oil repellent layer at a side of the second main surface.

11. The print layer-attached plate according to claim 1, further comprising an antifogging layer at a side of the first main surface.

12. The print layer-attached plate according to claim 1,
wherein the plate is formed of a glass.

13. The print layer-attached plate according to claim 12,
wherein the glass is a chemically strengthened glass.

14. The print layer-attached plate according to claim 1, being used as a cover for display devices.

15. A device comprising the cover for display devices described in claim 14, a frame supporting the print layer-attached plate, a display panel, and an adhesive layer sticking the print layer-attached plate to the display panel.

16. A functional layer-attached glass for in-vehicle display devices, comprising a plate having a first main surface and a second main surface, and a functional layer provided on the first main surface,
wherein the first main surface at least partially comprises a region formed of a recessed and projected layer having an arithmetic average surface roughness Ra of 4 nm or more and 1,000 nm or less, and the functional layer is formed so as to cover at least a part of the region.
